(19) United States
(12) Patent Application Publication
(10) Pub. No.: US 2007/0245397 A1
(43) Pub. Date: Oct. 18, 2007

(54) System and method for uploading TV firmware

(75) Inventors: J. Michael James, San Francisco, CA (US); Essam Aly, Dublin, CA (US)

Correspondence Address: MANATT PHELPS AND PHILLIPS;ROBERT D. BECKER, 1001 PAGE MILL ROAD, BUILDING 2, PALO ALTO, CA, 94304, US

(73) Assignee: Portrait Displays, Inc.

(21) Appl. No.: 11/787,457

(22) Filed: Apr. 16, 2007

Related U.S. Application Data
(60) Provisional application No. 60/792,044, filed on Apr. 14, 2006.

(51) Int. Cl. H04N 7/173; H04N 7/18; H04N 7/16

(52) U.S. Cl. 725/132; 725/140; 725/152; 725/80; 725/78

(57) ABSTRACT

A system and method for uploading firmware into television display is disclosed, in that it allows a user to upload firmware data to the user's television using conventional consumer technology, such as video media players with firmware encoded into a video format suitable for uploading firmware to the television through use of a conventional media player attached to the user's television display. Preferred embodiments of the system and method call for encoding firmware data into a format which is suitable for playback on a media player and communication to a television and the associated systems and methods in the television for decoding, processing and storing the new firmware data to the television set. Various embodiments of the invention disclose different methods of encoding and decoding, including, for example, image encoding, bar code encoding and Vertical Blanking Encoding methods for transmission of firmware data and decoding by the television.

### CROSS-REFERENCE TO RELATED APPLICATION

The present application claims priority from U.S. Provisional Application Ser. No. 60/792,044 filed Apr. 14, 2006, which is incorporated herein by reference in its entirety for all purposes.

### FIELD OF THE INVENTION

The present invention relates generally to systems and methods of uploading firmware into television displays and more specifically to methods and associated systems of encoding firmware data into a suitable medium and transmitting the firmware data to television displays in a format which can be decoded and stored in the television display.

### BACKGROUND OF THE INVENTION

Today's modern televisions (TVs) contain several features and options which are embedded in and implemented using the core firmware of the television set. Such features may include picture-in-picture, split screen programming, on-screen menus, high definition (HD) or digital image, video, sound and graphics capabilities, display calibration programs, Internet capabilities, compatibility with computer, gaming and device inputs, and other state of the art technologies that provide for a robust end user experience. Television manufacturers typically package and ship televisions with hardware and firmware that are compatible with and enable the newest technologies in the marketplace. For example, a user may chose a television set that features HD or has the ability to process the latest technologies such as Blu-ray, or some other graphical, video or sound options over another TV model which does not have those features.

However, for the average consumer, purchasing a television is usually a static experience. Once a user buys a television, that television will be not be updated over its lifetime to include newer technologies and capabilities that enter the marketplace after the manufacture and purchase of that particular television set. The technology that drives the television is often embedded in the television's firmware, a combination of software and hardware. ROMs, PROMs, EPROMs, EEPROMs and flash memory devices that have data or programs recorded on them are examples of firmware. When a TV is shipped, this firmware is usually coded by the manufacturer with the options and features that are available for a typical model and specification.

Although a manufacturer or a certified service engineer may be in the position to upgrade the firmware on a television by disassembling the television or using special tools to replace the firmware, this option is not available to the average consumer. Current television displays are not equipped with the capability to allow the average user an easy and consumer friendly method to update their television firmware. Once a user purchases a television, they will locked in with the options and features of that particular television, which may become quickly out of date and technologically obsolete in a relatively short time. In today's marketplace, televisions are becoming more and more like computers and offering a variety of advanced features. However, unlike computers, a user has no readily available means to update the firmware on a television to enable the latest upgrades and features.

### BRIEF SUMMARY OF THE INVENTION

Therefore, there is a need for a television and associated methods and systems that allow a television consumer to update or upgrade television firmware using conventional technology available to the consumer.

Preferred embodiments of the present invention describe systems and methods for using a video source such as a DVD player to send encoded firmware data to the television by, for example, playing a DVD with the firmware encoded in image data or through other means such as bar codes or using data sent during the Vertical Blanking Interval (VBI).

In some embodiments, firmware data is encoded into image data by using special computing tools that convert data from e.g., binary, decimal or hexadecimal format into a pixel value that can be processed and decoded by video processors on the television side. Authoring tools may also be used to write the encoded firmware data onto DVDs or some other video or image source.

Other embodiments of the invention address encoding firmware data into barcodes or in the non-visible portion of the data stream such as the Vertical Blanking Interval (VBI). Several different methods of encoding firmware data for quick and efficient transfer and processing by the television are contemplated by the present invention.

Yet other embodiments of the invention describe systems and methods for uploading the firmware and writing the firmware data to the memory device of the television set using drivers and embedded firmware logic.

The benefits of the present invention are enormous. A manufacturer can change the end user concept of buying a TV as a “lifetime investment”. Instead, the customer can buy the TV with confidence that the user can upgrade or update the TV periodically with the latest technologies. Using the described methods and systems, a TV can be converted from a black box object to an open system, by offering upgrades and by activating options that are already built into the original firmware of the TV. A manufacturer may repair and address problems in installed TVs and add new firmware to existing TVs. Several other benefits of the present invention will become obvious to one of ordinary skill in the art utilizing the systems and methods of the invention as discussed with reference to the exemplary embodiments herein.

### BRIEF DESCRIPTION OF THE DRAWINGS

FIG. 1 is a diagram illustrating typical components of a home entertainment system;

FIG. 2 is a diagram showing preferred embodiments of the image encoding method;

FIG. 3 is a diagram showing preferred embodiments of encoding firmware data in a RGB pixel;

FIG. 4 is a diagram showing a preferred embodiment of encoding a checksum byte in an encoded image row;

FIG. 5 is a diagram showing a preferred embodiment of a typical bar code used in the bar code encoding method;

FIG. 6 is a diagram showing a preferred embodiment of encoding firmware using the bar code encoding method;

FIG. 7 is a diagram showing a preferred embodiment of a sequence of images created using the bar code encoding method; and

FIG. 8 is a diagram showing a system and method of a preferred embodiment of uploading firmware data to a television.

### DETAILED DESCRIPTION OF PREFERRED EMBODIMENTS OF THE INVENTION

In the following detailed description of the exemplary embodiments, reference is made to the accompanying drawings that form part hereof, and in which is shown by way of illustration, specific exemplary embodiments in which the invention may be practiced. These embodiments are described in sufficient detail to enable those skilled in the art to practice the invention, and it is to be understood that other embodiments may be utilized and that logical, hardware, software and/or electrical changes may be made without departing from the spirit and scope of the present invention. The following detailed description is therefore not to be taken in a limiting sense.

Preferred embodiments of the invention relate to a system and method for uploading firmware to a TV using a DVD disk or other video source. The methodology can be used with any conventional television system using any type of video source, including DVDs, broadcast TV, game console, satellite box, etc. In some embodiments, reference is made to a television display with flash memory for storing firmware data. However, it is fairly contemplated by one of ordinary skill in the art that the invention be used with any type of programmable memory.

Preferred embodiments of the present invention comprise: encoding the firmware data, such as, for example, on a DVD disk or other video media content using PC tools and programs to produce the encoded firmware content; packaging the firmware data into a suitable medium; uploading the firmware from a video source to the television; and decoding the encoded firmware data from its video source into digital data. In preferred embodiments, a loaded driver sent from the video source performs the actual firmware transfer and update to the television memory device. In other embodiments, a firmware module within the television may be responsible for updating the firmware or alternatively, recognizing commands and data and launching a load driver to take over the operation of updating the TV firmware.

In exemplary embodiments of the systems and methods described herein, a user may upgrade a TV's internal embedded firmware using a DVD player (or, potentially, another video source). The end user can upgrade their TV with enhancements and newer core software using their conventional DVD players or other devices without need for a technician or any special connection or equipment, or even any specific knowledge on how televisions work.

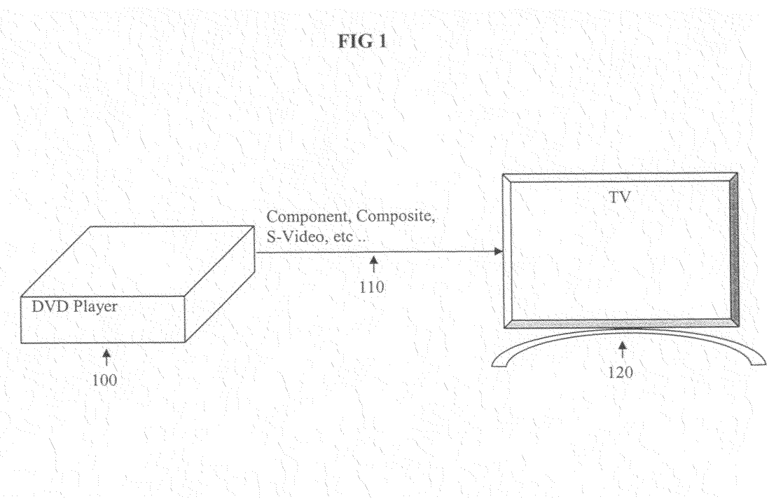

FIG. 1 shows a typical entertainment center/system with a DVD player 100, communications channel 110 (e.g., component video, composite video, S-Video, etc.) and a television (TV) 120. In one embodiment of the present invention, a DVD serves as an input device for the new firmware data. The system consists of a conventional DVD player 100 and TV 120 to be updated. These components exist in a typical entertainment center, which allows upgrading the TV with new firmware as simply as playing any DVD disk. For example, the end user can create a DVD using his computer after downloading the latest upgrade of the TV firmware as a DVD image from the Internet. The manufacturer can post the new firmware on their website periodically. Alternatively, the manufacturer can send an upgrade DVD to the end-user/owner of the TV. It should be noted that in FIG. 1 firmware memory of some type resides within television 120. Typically, flash memory would be used, but any Erasable Programmable Read-Only Memory (EPROM), or its functional equivalent, can be used. In exemplary embodiments discussed herein, the firmware memory device may be referred to as “flash memory”, or “firmware memory”.

In one embodiment, a DVD disk carries data that is to be uploaded to the TV's flash memory. That data is the new, updated firmware encoded on the DVD as media content. The TV contains its current core firmware, stored in firmware memory which comprises code that recognizes data sent from the DVD, and will determine that the TV is being instructed to upload the data as new firmware. In preferred embodiments, the portion of code residing on the TV is responsible for recognizing the firmware data, loading it, and finally installing it into the TV's firmware memory as the TV's new firmware. In other embodiments a load driver may handle some or all of these tasks.

In preferred embodiments, the end-user loads the DVD disk into the DVD player just as if the user were playing a movie or other program. When a picture appears on the TV screen the user presses the enter key on the DVD remote control to start the upload. The TV takes care of the rest, and re-boots itself after finishing the upload. It will inform the end user of the progress of the upload and update throughout the process.

Encoding the Firmware Data

In the DVD embodiment, content is authored based on the method that is used to encode the data of the new firmware on it. A number of different methods of encoding firmware may be used. Encoding tools and software are used to encode the new firmware data in the form of video content that can be recorded on a DVD, or otherwise made available for distribution and use with the designated TVs. In preferred embodiments, three methods of encoding are described below, including the Image encoding, Bar Code Encoding and Vertical Blanking Interval (VBI) Encoding. The methods of encoding, however, are not limited to these three methods and one of ordinary skill in the art will recognize that other known methods can be used. The encoding and therefore the corresponding decoding mechanism can use different methods to achieve the same goal when transferring the new firmware from the DVD disk (or other video source) to the TV for processing.

Encoding the Firmware into a Video Format

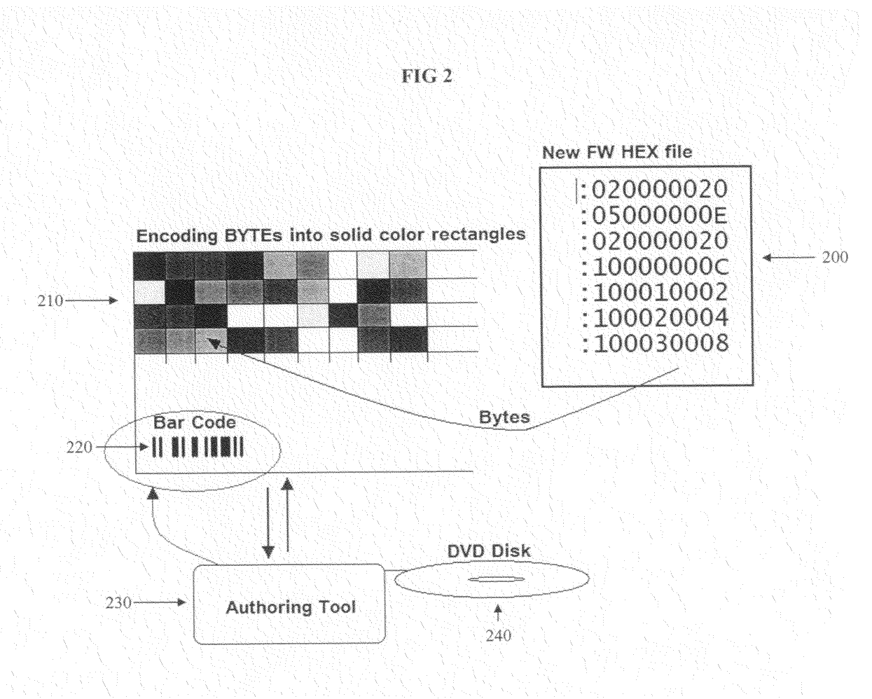

In some embodiments of the invention, a firmware file format is an Intel HEX file. FIG. 2 shows how a new firmware HEX file 200 is converted to an image file (210 and 220). The Intel HEX file is an ASCII text file with lines of text that follow the Intel HEX file format. Each line in an Intel HEX file contains one HEX record. These records are made up of hexadecimal numbers that represent machine language code and/or constant data. Intel HEX files are often used to transfer the program and data that would be stored in a ROM, Flash memory, or EPROM. In preferred embodiments, TV firmware is saved in HEX format. Using personal computer tools and software one can create HEX files, and generate 24-bit bitmap (BMP) files, for the Image Encoding Method, or alternatively for the VBI method, CC, XDS or Teletext files may be created. As shown in FIG. 2, a PC authoring tool 230 may be used to author a DVD disk 240 or other video containing the encoded firmware content. In exemplary embodiments described herein, firmware, commands and data may be encoded as color images 210 or bar codes 220, or within the Vertical Blanking Interval (VBI).

Using the image encoding method, each byte may form a Red-Green-Blue (RGB) value represented in solid color blocks 210. These values will be a solid color value that can be used to draw a color block 210. In one embodiment, that block may comprise 5×5 pixels. However, different pixel sizes for encoding data are contemplated by the present invention. Different sizes will impact the calculation of the transfer rate in the Image Encoding Method. Using variable sizes may enhance the data transfer and decoding rate.

FIG. 2 also shows the possibility of adding a barcode 220 to indicate and determine, for example, which image, what page, and in which sequence the images are to be decoded. The usage of barcodes as described in exemplary embodiments is suggested but not required for this operation.

The Image Encoding Method

The image encoding method is one method of encoding the new firmware data bytes. In a preferred embodiment, each set of new firmware bytes may be encoded into one pixel using a color format. For example, RGB format can carry up to 24 bits of data per pixel. However because of compression/decompression, the possibility of loss of data bit resolution during color space conversion, noise, and/or the video decoder that might be involved in the image path decoding process, using this format to encode only 8 bits is preferred. Accordingly, the loss of any of the other 16 bits of the total 24 bits during any conversion would be tolerated, and still deliver accurate data values to the TV. In one embodiment, a PC encoding tool will pack each firmware byte into one-pixel RGB form (value). The descriptions below are examples of packing one byte of firmware data into a 24 bit wide RGB value, which will later be the basis of a solid color box that will be drawn on a BMP file.

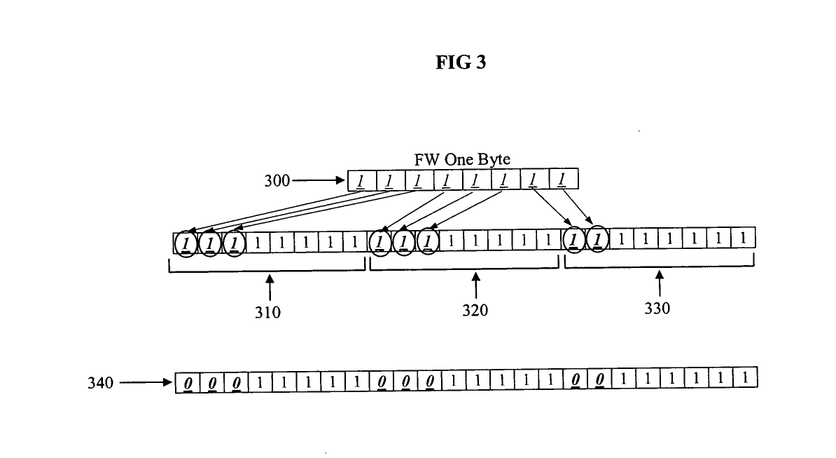

As shown in FIG. 3, to encode a firmware byte 300, e.g., value 0xFF into an RGB pixel value, red byte 310 will carry the leftmost 3 bits of that byte, green byte 320 will carry the middle 3 bits of that byte and finally the blue byte 330 would carry the rest. It is also possible to arrange, for example, for the green component to carry more bits. FIG. 3 also shows an example 340 of how to encode, e.g., byte value of 0 in to a 24 bit RGB value and to avoid making it appear black. In this example, one pixel of RGB 0x1F1F3F includes 0x0 Byte value of firmware code.

The below describes an image coding example. In this example, each byte is truncated into 3 groups: the far left 3 bits group, middle 3 bits group and finally the last 2 bits group.

```
  typedef struct tagBYTE
  {
```

| | |
|---|---|
| unsigned int LEFT_3_RED | :3; // (Group A) |
| unsigned int MIDDLE_3_GREEN | :3; // (Group B) |
| unsigned int RIGHT_2_BLUE | :2; // (Group C) |

```
  } ENCODED_BYTE;
  ENCODED_BYTE  eByte=0;
  unsigned long  rgb =0;
  // Read one byte into the ‘eByte’ variable
  eByte = HexFileBuffer[0];
  // Encode one Byte into 24 bit RGB value..
  // Note that we are turning the unused bits ON
  // And we are not using the high significant 8 bits of the ‘rgb’
  long value
  rgb =
  (eByte.LEFT_3_RED  << 21) | (0x1F) \// Encode (Group A) in
  RED
  (eByte.MIDDLE_3_GREEN << 13) | (0x1F) \// Encode (Group B) in
  GREEN
(eByte.RIGHT_2_BLUE  << 6 ) | (0x3F) ;// Encode (Group C) in BLUE
```

As will be appreciated by one of ordinary skill in the art, alternative means can be used to encode, for example, one byte (8 bits) of firmware data into a 24-bit RGB color value. For example, the number line between 0 and 2²⁴-1 can be divided, for example, into 2⁸ (256)+2 roughly equal-sized segments, so that the troublesome all-zeros and all-ones cases are eliminated, and the values 0 through 255 can be encoded as points at the segment boundaries. Or, if it is determined that a non-linear mapping from 256 values to 16,777,216 million potential values in 2²⁴ is more appropriate, for example, because some sets of values are better distinguishable from each other than others after being transformed from the video source through to the TV set, such a mapping can be used instead.

In the preferred embodiments described herein, a checksum may be required to ensure correct delivery of the firmware bytes. The checksum may occur between each phase and possibly can be used to arrange a request for retransmission of the data if needed. However in a one-way (unidirectional) communication such as a DVD to the TV method described here, a request for retransmission would be impossible. A method which does not require any retransmission is contemplated. Forward error correction is a technology well-known to those of ordinary skill in the arts, which can accomplish this objective. At the cost of somewhat more data to be transmitted, it can correct most transmission errors, and also offers more conservative detection of errors than many straightforward checksum schemes.

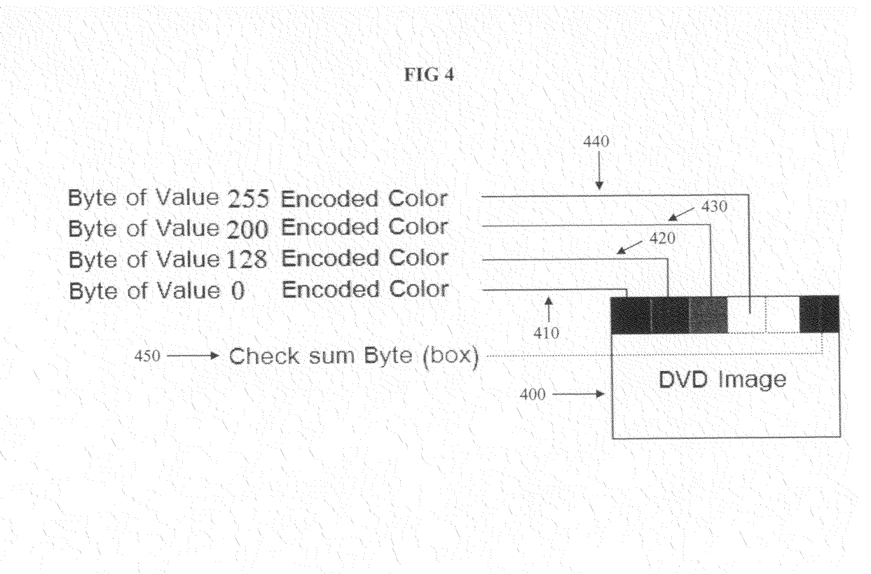

FIG. 4 depicts an example of how firmware date is encoded with a checksum. Image 400 carries color blocks, 410, 420, 430 and 440 with encoded firmware data. The decoding method, described in more detail below will read each color block 410-440 (possibly of 5×5 size) as a representative of a “Byte” and decode its SOLID color RGB value to extract and construct the byte value and store it in a separate allocated place in memory. The checksum box 450 (byte value) is added to the end of the row.

In preferred embodiments of the image encoding method, new firmware data may be presented in different formats and configurations depending on the processing and decoding capabilities of the TV. As discussed in previous examples, each byte of data may be represented as a solid color box. Its minimum measurement, however, depends on how the TV may scale it. For example if the TV scalar can never scale a 5×5 color box to be less than a 2×2 box, then a 5×5 box would be sufficient.

The page size may also impact the data transfer. In a typical 720×480 format TV, the 720 pixel width means 144 boxes of size 5 pixels in one row, and 96 boxes of the same size in one column. In this example, 144*96 equals 13,824 bytes, which is how many bytes an image can carry with these dimensions.

The decoding duration for each image is also considered for the image encoding method. Maximizing the speed and efficiency of data transfer is desired. For example, to decode and save each image's 13,824 bytes may be a time consuming operation. The decoding time may govern how long each image remains displayed from the DVD or other video content. The fetching and decoding process for 13,824 bytes may be a slow process. Thus, each encoded image may be displayed for a second or more. The maximum image update rate, and thus the maximum data transmission rate, must be limited by design to a rate which the TV is capable of handling. Since the TV model, or range of TV models is known for a given update DVD or other video content, this can be conservatively chosen to reflect the limit imposed by the slowest conversion rate available among the selected models.

For a typical modern TV firmware size of 1,782,165 bytes, it will require approximately 129 images to encode and transmit all bytes (without the use of forward error correction), as each image will carry 13,824 bytes in this example. Assuming a conservative decoding process, where one image is decoded per second, 129 images can be decoded in 129 seconds. Thus, transmission of new firmware in this case may take approximately 2 minutes and 9 seconds. Assuming an extremely slow decoding process, for example, comprising a decoding rate of one image per 4 seconds, the 129 images will be decoded in 129*4 seconds, equal to 516 seconds. In this example, it will take 8 minutes and 36 seconds to transfer the new firmware data.

It is contemplated in several embodiments, that different approaches are considered in deciding how much data to encode per image and how best to encode that data. For example, it is contemplated that instead of encoding 13,824 bytes in each image (which may take a relatively long time to update the firmware because the decoding process of such images by the TV firmware takes considerable time) another approach can also be used. By using a seek-and-fetch algorithm, it is possible to encode fewer bytes in each image, and encode them in a specific location on the image such as location 0,0 (x of 0 and y of 0). This speeds the process of fetching the bytes, and allows efficiently decoding 60 images per second. Thus, it is possible to vary the decoding rate by using fewer images consisting of more bytes, with each image taking longer to decode, or more images with fewer bytes, with each image taking less time to decode.

In one embodiment of the invention, encoding of 15 images per second on a DVD and decoding them at the same rate is possible. This can be used to optimize the upload period. Each set of 15 images may be encoded in one second. For example, if 9 seconds is needed to encode 135 images, then to encode and decode 128 images would be less than 9 seconds.

The below calculations illustrate examples of different image encoding considerations.

### EXAMPLE ONE

### The solid color box width is 5 and its height is 5.

### The total bytes in the firmware are 1,782,165.

### The TV resolution is 720×480 pixels

### Assume the TV can decode one image per second.

### How many boxes per row=720/5=144

### How many boxes per column=480/5=96

### How many solid color boxes per image=144*96=13,824 boxes

### Each box represent one byte, the number of bytes per image=13,824 bytes

### How many images are needed to hold all of the firmware bytes=1,782,165/13,824=129 images

### Total time needed to decode all the firmware into the TV=129 images*1 second=129 seconds

### Total minutes=129/60=2 Minutes 9 seconds

### EXAMPLE 2

### The solid color box width is 10 and its height is 10.

### The total bytes in the firmware are 1,782,165.

### The TV resolution is 720×480 pixels.

### Assume the TV can decode one image per second.

### How many boxes per row=720/10=72

### How many boxes per column=480/10=48

### How many solid color boxes per image=72*48=3,456 boxes

### Each box represent one byte, the number of bytes per image=3,456 bytes

### How many images are needed to hold all of the firmware bytes=1,782,165/3,456=516 images

### Total time needed to decode all the firmware into the TV=516 images*1 second=516 seconds

### Total minutes=516/60=8 Minutes 36 seconds

As described above, an image may comprise (for example) 13,824 boxes of solid colors. In this example, each box encodes 8 bits (one byte) of the new firmware. It should be noted that bytes may be encoded with consideration of possible errors in byte values due to, for example, bad Digital to Analog Converters (DACs), Analog to Digital Converter (ADCs) or a noisy or poor connection. Each byte is encoded in the most significant part of each solid color RGB value. This method will avoid the risk of losing significant parts of any byte's value during the DAC and ADC conversion, and ensure a safe arrival of each firmware byte. The unused bits may be filled with 1s (ones), to give the ability of encoding the value of ZERO without having to calculate the lowest RGB values that represent BLACK in the TV image path. ZERO usually corresponds to BLACK in the RGB color space, however, BLACK is indicated by the value 16 in the luma-chrominance YUV format, which is often used for composite video signals.

The incoming programming signal, from a DVD or other video source, typically will go through an MPEG decoder and a DAC before being sent to the TV itself. A typical TV image signal path includes an ADC. This image signal path thus affects the RGB values of the original pixels. There is a chance that the pixels carrying the firmware bytes may not deliver accurate firmware byte values. This possible problem can be avoided at the DVD and video content programming phase. However, if that is not possible, then the barcode method may be the most efficient to use, as it ensures delivery of accurate values that are encoded into the barcode.

The Barcode Encoding Method

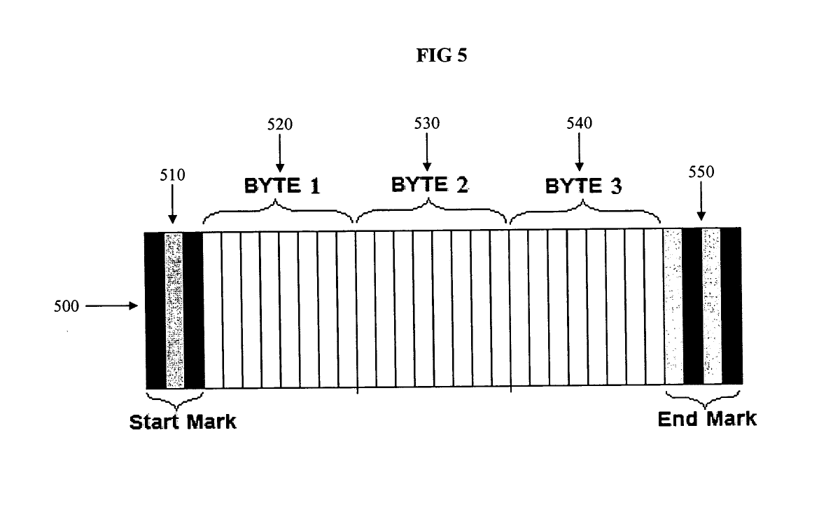

In exemplary embodiments described herein, firmware bytes may be encoded in bar codes for display and processing on the television. As shown in FIG. 5, barcode 500 may consist of 31 bars. The first 3 bars, start mark 510, form the binary digits “101”, which is used to identify a “Start”, e.g., Portrait Displays, Inc. (PDI) barcode. The next 24 bars can represent 24 binary digits, which would be equal to 0xFFFFFF if all the bars were black. The last 4 bars, end mark 550, may represent the binary digits “0101” which used to mark the “End” of the PDI barcode. The firmware data may be encoded in byte 1 (520), byte 2 (530) and byte 3 (540). Additional barcode that instructs the TV to perform tasks such as when to start, when to end, or to identify the nature of the data may be inserted at this stage.

In this example, each barcode can carry up to 3 full bytes. This barcode capacity may be changed to carry more bytes, however in this embodiment, barcodes that carry 3 data bytes are described. Barcodes used in programming firmware of a TV are usually black and white only (without boundaries), to represent the binary digits of “1” with black and the digits of zero with white. Every BLACK bar represents the binary digit “1” and every WHITE bar represents the binary digit “0”. A typical barcode may use approximately 130 to 140 pixels of the image width and around 4-5 pixels in height.

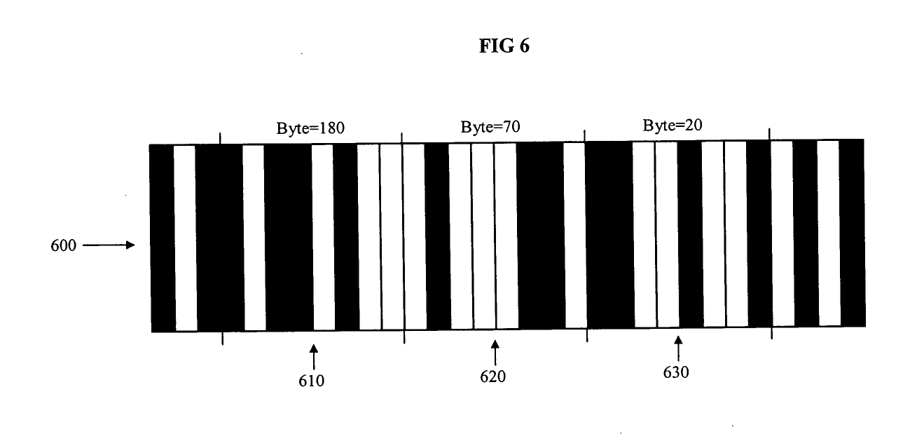

To represent 3 bytes, assume the following example as depicted in FIG. 6:

### The 3 bytes have a value of 180, 70, 201 in decimal, which can be represented in binary as “10110100 1000110 11001001”. As shown in FIG. 6, the values 180, 70 and 201 are encoded in the barcode as byte 1 (610), byte 2 (620) and byte 3 (630).

The transfer rate using the bar code method will depend on how many barcodes can be displayed in one image, and thus how many images are created per firmware HEX file. The decoding time of a whole image filled with barcodes will determine the number of images to be decoded in a one-second program. A basic calculation may be that one image of 640 (w)×480(h) may include approximately 5 barcodes per row, assuming an average bar code width of approximately 130 pixels. If the barcode height will be approximately 5 pixels, then it is possible to display 96 barcodes per column. In this example, the total number of barcodes is 5 multiplied by 96, which equals 480 barcodes per image. As every barcode can contain 3 bytes, cthe total bytes that can be encoded and decoded in one image (of this example) is 1,440 bytes. For a typical modern TV firmware file size of 1,782,165 bytes, approximately 1,238 images are required in this example. If a television is able to decode 30 images completely in one second, then the required time to decode the entire firmware will be 42 seconds.

In an example of a lower decoding rate scenario, if the television can only decode 15 images per second, the total required time is ((1,782,165 bytes/1,440)/15) which is approximately 83 seconds.

In another example of a lower decoding rate scenario, if the television can decode only 10 images per second, the total required time is ((1,782,165 bytes/1,440)/10) which equals approximately 124 seconds, or two minutes and 4 seconds.

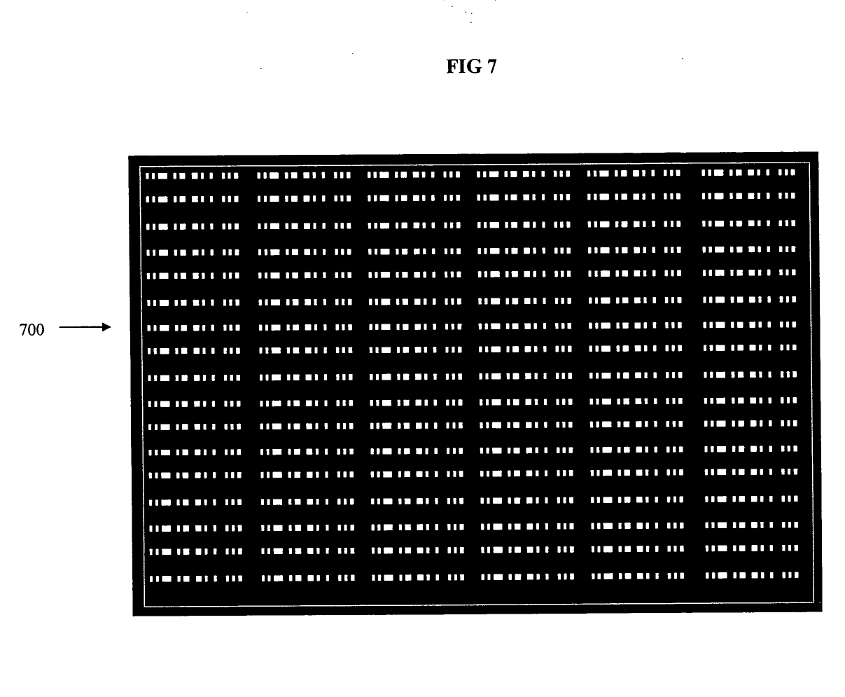

FIG. 7 illustrates an image 700 of bar coded bytes. This figure shows the output of the PC tool that takes HEX files as an input and generates sequence of bar code images that encodes the HEX file bytes.

Vertical Blanking Interval (VBI) Encoding Method

The Vertical Blanking Interval (VBI) encoding method is way to encode the new firmware data bytes. This method may be preferred over the image method, as the VBI method ensures the delivery of accurate data, that is not in the same compression or decoding path as the image method. Hence, the loss of data would be zero. In fact, it ensures a 100% accuracy of bits delivered to the TV side from the DVD disk or other video source.

Using this system and method, the new firmware data may be encoded as Closed Caption (CC) or eXtended Data Service (XDS) Data. The new firmware data bytes may be inserted in the DVD disk or other video stream as XDS data or as CC data, or the Teletext form of data, which may also be used. The point is to transfer the data from the DVD disk or other video source to the TV via a different channel other than the image path. If the data is presented as CC or Teletext, it is preferred to make the data invisible on the screen. However, if such data appears on the screen it will appear faster than anyone can possibly be able to read it, and a user may believe that there is something wrong with their television set. It is contemplated, therefore, that a warning message may be displayed to the end user during the firmware upload process when the VBI method is use. The image method will result in similar behavior if display blocks of solid colors as fast as 15 different images per second are used. If the end user is not previously warned about how the display will look while the firmware is being loaded, it may appear to the end user that something may be wrong with the TV.

In different embodiments of the invention, the transfer rate using the VBI method may vary. Each frame can carry limited amount of bytes with CC or XDS, but the benefit is that it is possible to distribute the data bytes of the new firmware over a long sequence of frames (and still use the visible area for other images). As it is described above as an option in the Image Encoding method, fewer bytes per frame, and much faster decoding of such images results in an approximate decoding time that is equal to encoding many bytes per frame and more elapsed time to decode each frame.

In exemplary embodiments, the transferring and decoding of the XDS, CC or Teletext data may be faster than the decoding of the Image data. This process does not involve any conversion or color space calculations. It is straightforward to capture the data bytes as is.

The decoding rate calculation depends on the system implemented. Every TV platform, such as Genesis, Pixelworks, or others, has its own way of handling the VBI data. The calculation simply will depend on how many bytes can be transferred per frame (or frames) and how many frames can be decoded per second.

In preferred embodiments of the invention, a PC tool will be required to pack the new firmware bytes and produce CC, Teletext or XDS formatted files. Special software tools known to one of ordinary skill in the art may be used to create CC or teletext data files. If any current market tools offers packing raw bytes into CC files or Teletext or XDS files it is contemplated that such tools are a logical choice to use with the present systems and methods.

In some aspects of preferred embodiments of the invention which require converting the new firmware bytes into a VBI data format that is associated with each frame (or frames) of the DVD or other video content, it is recommended to add the check sum at the end of each packet, assuming that each frame (or group of frames) will hold one packet.

The specially formatted firmware files (e.g., image, bar code, VBI, etc.) consequently will be used with an authoring tool to create a DVD disk or other video content that contains the specially formatted data files. For example, any authoring tool that allows VBI insertion is contemplated. For example, “Encore 2.2” or later versions may be a suitable choice. The authoring tool will use the files that were produced by the PC tool to author the DVD disk.

It will be appreciated in preferred embodiments of the invention that it is necessary to arrange the decoder so it can easily tell when the image has changed to the next data image. This can be accomplished, for example, by reserving one byte or a few bytes for a sequential counter that can be used at the decoder to detect that the next data image has been displayed. For example, a Gray code can be used, to avoid possible timing ambiguities in detection of multiple-bit changes in such a counter. Other mechanisms will also be readily apparent to one of ordinary skill in the art.

The preferred embodiments disclose a number of ways of coding the information to be transmitted to the TV set within a video signal. Other coding schemes, using, for example, designs that are carefully chosen to be easily decodable, but where codes can be readily distinguished from each other in color space in the presence of coding error, compression and decompression error, and channel noise, will be readily apparent to one of ordinary skill in the art.

In addition to the usual checksums, described above, forward error correction algorithms may also be used at the encoding stage, and applied by the decoding stage, to reduce or eliminate transmission errors, and thus to simplify the process of firmware upgrading. Possible choices for algorithms will be readily apparent to one of ordinary skill in the art.

In addition, it will be appreciated that, instead of transmitting each and every byte of revised firmware, it is possible to compress the new firmware, or to express the new firmware in terms of differences with the firmware already installed in the TV set, thus potentially reducing the total amount of data that must be stored, transmitted, and decoded by the TV set.

Further, it will be appreciated that such firmware upgrades may potentially render the TV set inoperable if they are not correctly applied. Thus, the system and method shown here also contemplate performing validity checks on the new firmware before applying the firmware upgrade to the TV. In addition, it is possible to configure such a system with a permanent firmware loader that cannot be erased, as a fallback should the primary firmware within the TV accidentally become inoperable or corrupted.

Firmware Upload

In exemplary embodiments, the data bytes of the firmware streamed from the DVD or other video source must be saved somewhere in the memory (RAM/SDRAM) of the TV until the decoding is complete. The preferred embodiments of the system require that the TV to be updated with new firmware be compatible for uploading newer firmware. Therefore, the television hardware architecture should comprise devices that are by nature reprogrammable with new firmware. An example of such devices are flash memory devices. It is contemplated in embodiments of the invention that the TV hardware architecture comprises firmware that is designed to be upgraded with new software.

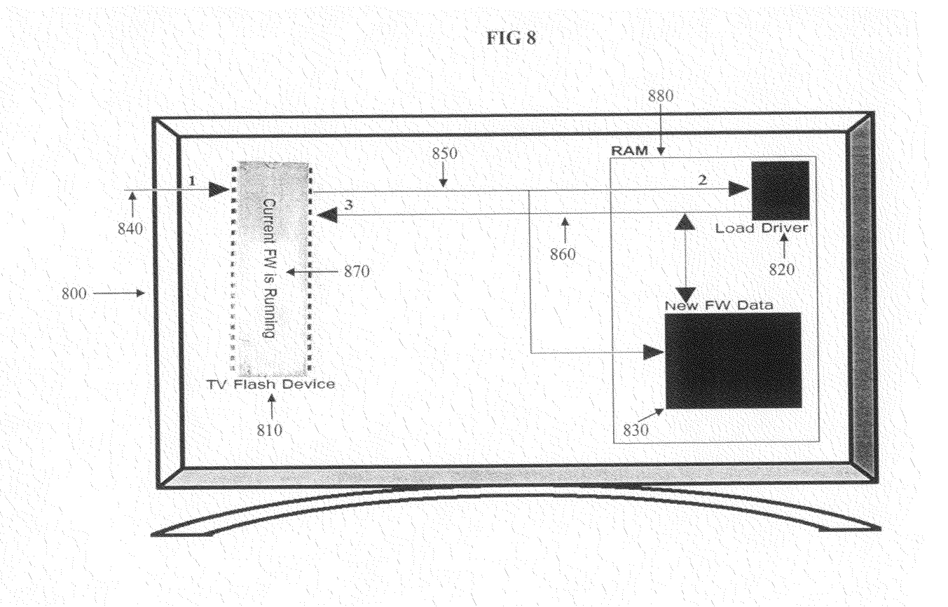

FIG. 8 shows a preferred embodiment of a television architecture and data flow operation for updating firmware inside television 800 using the present invention. In this example, new firmware data 830 is streamed (arrow 840) from the firmware data source such as a DVD player or other content source. The television 800 has current firmware 870 running on flash memory device 810. The new firmware data 830 is initially processed by the current firmware 870. Arrow 850 shows the transfer of the new firmware data 830 to RAM 880 along with Load Driver 820. As shown by the arrow (860), the Load Driver may take over transferring the new firmware data bytes and write those bytes to the TV's flash memory 810 (any other suitable programmable device may be present).

In some preferred embodiments, the DVD disk may carry a form of a low level DRIVER that will be responsible for running on the TV side, and transferring the new firmware from the TV's RAM memory to the TV programmable device. This means that driver has to be packed and decoded prior to the new firmware data being written, saved in the TV RAM, and also instructed to where the new firmware data can be found in the RAM. Once the total transfer of the driver and new firmware bytes to the TV memory (e.g. RAM) is complete, the control of the execution may be given to that driver. Thus, the current firmware that is running on the TV, which was the one that initially transferred all of the data from the DVD or other video source, can be replaced in the process. Using this method the old firmware may be overwritten with the newer firmware. In other embodiments, the embedded logic in the TV code may handle the entire transfer of the new data bytes and write them into the TV's flash memory device.

In exemplary embodiments, once the DVD contents or other video content are streamed to the TV input channel the firmware “logic” within the TV recognizes and decodes the commands and the data that are sent. That logic is the embedded firmware portion of the TV. It is contemplated by the present invention to modify the current TV firmware to include such logic.

In some embodiments, a piece of firmware code residing on the TV may comprise the embedded firmware. As the embedded firmware loads the new firmware data and saves it to the TV RAM it also loads the second piece of code, or logic, and saves it into the RAM as well. Once both pieces are loaded, the existing embedded firmware in the TV gives control over to the second piece of code. The second part of the logic, as described earlier, may comprise the “Load Driver”. In some embodiments it is referred to as the “In-System Programming (ISP) Driver”.

In exemplary embodiments, the embedded firmware (first part of the logic) may carry out the following types of functions: recognize Flags and Instructions; recognize all commands embedded in all images that are sent to the TV; recognize any VBI data sent, and carry out the specified functionality at the TV; decode the streamed data (whether it is VBI or image data) and save the data into the RAM; and recognize what part of the data is the Load Driver and which is the new firmware data; launch the load driver to take over and move the data from the RAM into the flash memory of the TV.

The Load Driver, or second part of the logic may be responsible for moving the loaded data bytes from the RAM into the TV's flash memory.

In preferred embodiments, the Load Driver and/or embedded firmware is TV manufacturer-specific code. The embedded firmware or driver may be supplied by the scalar (or manufacturer) designer. It is contemplated by the present invention that the Load Driver or the embedded firmware may be modified or manufactured to include the following functions: having the ability to recognize location of the firmware data bytes in the TV's RAM; having the ability to move/copy/burn the firmware data into the TV's flash memory, instead of the traditional streaming of those bytes from a serial port or I²C connection; being able to display a progress notification to warn the user not to disconnect the power during the process, and to provide an indication of when the process is going to end; and having the ability to re-boot the TV system right after finishing the upload and the writing of the new firmware. Other functions are also contemplated by the present invention.

It will be appreciated by one of ordinary skill in the art that it is also possible to configure the system so that the TV's firmware remains viable even if the system power fails during the firmware update process. This can be done, for example, by using two banks of flash memory for storing the firmware in the TV set, and arranging that the TV set boot from the most recent bank that has a correct checksum. Thus, even if the updating of firmware in the flash memory is interrupted by a power failure, the TV set will still operate.

While the present invention has been described in connection with a number of embodiments and implementations, the present invention is not so limited but rather covers various modifications and equivalent arrangements, which fall within the purview of the appended claims.

What is claimed is:

1. A system for uploading firmware into a television comprising:
a television;
a video source coupled to said television via a communications channel for sending video images with encoded firmware data to said television;
a module within said television for decoding the encoded firmware data from said video images; and
a programmable memory device within said television for storing said firmware data.

2. The system of claim 1 wherein said video images further comprise embedded commands.

3. The system of claim 1 wherein said video source comprises a DVD player and DVD.

4. The system of claim 1 wherein the module is loaded into the television via the video source.

5. The system of claim 1 further comprising:
a Random Access Memory (RAM) unit within said television for receiving firmware data;
and a load driver transmitted via said video source for transferring data from said RAM unit to said programmable memory device.

6. The system of claim 2 further comprising:
a Random Access Memory (RAM) unit within said television for receiving firmware data;
and a load driver transmitted via said video source for transferring data from said RAM unit to said programmable memory device.

7. The system of claim 6 wherein the module within said television further
recognizes the embedded commands;
processes the commands to initiate the firmware upload process;
extracts the firmware data from said images;
transfers the firmware data into the RAM unit;
recognizes the load driver;
and directs the load driver to transfer the firmware data from the RAM into the programmable memory device.

8. The system of claim 7 wherein the programmable memory device is a flash memory device.

9. A method for uploading firmware into a television, comprising the steps of:
encoding firmware data in video images;
sending said video images to a television using a video source;
decoding said video images within said television;
extracting firmware data from said video images; and
storing said firmware data to a programmable memory device within said television.

10. The method of claim 9, wherein the firmware data is encoded in Red Green Blue (RGB) format visible to the end user.

11. The method of claim 9, wherein the firmware data is encoded in bar codes visible to the end user.

12. The method of claim 9, wherein the firmware data is encoded for transmission during the Vertical Blanking Interval (VBI).

13. A method of writing firmware data to a television display, comprising:
using a software tool to encode firmware data from a data format to a video format;
using an authoring tool to create video media with encoded firmware data;
playing the media on a media player which communicates with the television display;
commanding the media player to upload the encoded firmware data to the television display in a video format;
decoding the firmware data in the television;
storing the firmware data in a memory device within said television display.

14. The method of claim 13, wherein the data format is selected from a group consisting of the following formats: binary, decimal and hexadecimal.

15. The method of claim 13, wherein the data format comprises hexadecimal format and the video format comprises files containing bitmap images corresponding to the encoded firmware data.

16. The method of claim 14, wherein the video format comprises files containing bitmap images corresponding to the encoded firmware data.

17. A method of writing firmware data to a television display, comprising:
using a PC tool to encode firmware data from a data format to Vertical Blanking Interval (VBI) format;
using an authoring tool to create video media with encoded firmware data;
playing the media on a media player which communicates with the television display;
commanding the media player to upload the encoded firmware data to the television display in a Vertical Blanking Interval (VBI) format;
decoding the firmware data in the television;
storing the firmware data in a memory device within said television display.

18. The method of claim 17, wherein the data format is selected from a group consisting of the following formats: binary, decimal and hexadecimal.

19. The method of claim 17, wherein the VBI format comprises the encoded firmware data in closed captioning (CC).

20. The method of claim 17, wherein the VBI format comprises the encoded firmware data in teletext.

21. The method of claim 17, wherein the VBI format comprises the encoded firmware data in XDS.

22. A computer-readable storage medium storing program code for causing a media player and associated television firmware to perform the steps of:
transmitting encoded firmware data to memory in said television display;
decoding the encoded firmware data from a first format to a second format;
storing said firmware data in a second format in programmable memory of said television display.

23. The computer-readable storage medium claim of claim 22, wherein said medium is a DVD and said media player is a DVD player.

24. The computer-readable storage medium claim of claim 22, wherein the first format comprises a video format and the second format comprises a digital format.
